(19) United States
(12) Patent Application Publication
(10) Pub. No.: US 2013/0162625 A1
(43) Pub. Date: Jun. 27, 2013

(54) Displayed Image Improvement

(71) Applicants: Michael L. Schmit, Cupertino, CA (US); Shivashankar Gurumurthy, Santa Clara, CA (US); William Herz, Hayward, CA (US)

(72) Inventors: Michael L. Schmit, Cupertino, CA (US); Shivashankar Gurumurthy, Santa Clara, CA (US); William Herz, Hayward, CA (US)

(21) Appl. No.: 13/336,465

(22) Filed: Dec. 23, 2011

(51) Int. Cl. G06T 15/00; G09G 5/02; G06T 17/00

(52) U.S. Cl. 345/419; 345/428; 345/589

(57) ABSTRACT

A image processing system for displaying a source image includes a memory for storing a source image having a high resolution digital format, a display screen having a low resolution digital format, and a media acceleration hardware unit adapted to increase color depth values from the source image and generate a plurality of temporally shifted images from the source image by sequentially shifting an origin point for a frame applied to the source image and scaling source image pixel values from each frame, thereby generating the plurality of shifted images having the second, relatively low resolution for display at the display screen.

### BACKGROUND OF THE INVENTION

1. Field of the Invention

The present invention relates in general to image processing technology. In one aspect, the present invention relates to the display of digital image information.

2. Description of the Related Art

Digital images are typically displayed on display screen devices (e.g., PC monitors and TV displays) that have a fixed number of pixels and color depth. For example, consumer video formats (such as ATSC for broadcast HDTV, DVD and Blu-ray discs) specify the use of the MPEG-2 standard at main profile high level which has a maximum resolution is 1920×1080 and a 4:2:0 color space that has 8-bits per sub-pixel. Even high definition (HD) displays using the RD 1080p format can display only 2M pixels. However, the digital image and video source content typically has more information (e.g., resolution and color space depth) than can be displayed on existing display screen devices. For example, a variety of image sources, including videos streamed from the Internet and still image photographs taken by cameras or provided over the Internet, have a source resolution (e.g., a total of 5M pixels or even 10-20M pixels) that is far higher than the available resolution of a display screen. Even YouTube videos can have source resolution that is larger than most screens.

To display high resolution images on lower resolution displays, heavy downscaling is typically used whereby the image is scaled to reduce the number of pixels from the source image to fit the display size. In the example of a conventional display or playback device 10 shown in FIG. 1, an input image is received that might be part of a digital photo taken by a camera with a resolution of 3840×2160 or some other high resolution format. The input image is processed by image decoder 2 by scaling the input image for display on the display 8 which has a lower resolution and different color depth capability (e.g., 1920×1080 pixels with a color depth of 10-bits). The decoder 2 receives the input image at input buffer 3, performs JPEG-type image decoding JPEG decoder 4 to generate high resolution image pixels 1, and then downscales the high resolution image pixels 1 at downscaler 5 to generate the downsampled output image 6 that is stored in the current frame buffer 7 for output to the display 8. With a conventional image scaling approach such as shown in FIG. 1, the downscaler 5 takes group of pixels from the high resolution image pixels 1 (e.g., a 2×2 pixel group), computes the average value of that group, and uses the computed average value as a single output pixel for the output image 6. Of course, more complex scaling algorithms may be used, but they still generate output images with reduced resolution and contrast, as demonstrated by the gray transition shading shown in the downsampled output image 6.

Accordingly, a need exists for an improved image display scheme which addresses various problems in the art that have been discovered by the above-named inventors where various limitations and disadvantages of conventional solutions and technologies will become apparent to one of skill in the art after reviewing the remainder of the present application with reference to the drawings and detailed description which follow, though it should be understood that this description of the related art section is not intended to serve as an admission that the described subject matter is prior art.

### SUMMARY OF EMBODIMENTS OF THE INVENTION

Broadly speaking, the present invention provides a display device, architecture, system, and method of operation for increasing the perceived spatial resolution of a displayed image beyond the physical number of pixels in the display device and/or for displaying an output image with greater color depth than is included in the source image content. In selected embodiments, the perceived spatial resolution is increased by generating, downscaling, and displaying a plurality of slightly shifted images over time, thereby rendering a series of images rendered with different shifts that effectively convey visual features which are lost with conventional image downscaling. By carefully controlling the shift distance and amount of time between displaying the shifted images and selecting appropriate image scaling algorithms, very fine edges in the original source image will appear sharper in the display image than they would otherwise in a purely static image without appearing that the image is moving. In other embodiments, the processing of the source image generates a downsampled output image with greater color depth than is in the source image by logically promoting each smaller bit depth pixel value (e.g., 8-bit values) from the source image to a larger bit depth pixel value (e.g., 10-bit values) and then using the computed average of the surrounding smaller bit depth pixel values as a larger bit depth pixel bit value that can be sent to the display. In this way, spatial averaging is used to replace an 8-bit pixel with 10-bits or more of color depth information per sub-pixel for display. In selected embodiments, the image shift and spatial averaging techniques are combined to provide higher resolution and greater color depth.

In selected example embodiments, an image processing system and method of operation are disclosed for displaying a source image using a memory, media acceleration hardware, and a display. The memory is provided for storing a source image having a first relatively high resolution digital format, and a display screen is provide for displaying images. The source image may be a 2D image, paused video image, or 3D image, in which case the media acceleration hardware may be adapted to transform three-dimensional input source information into a two-dimensional source image by converging left and right images from the three-dimensional input source information into co-located pixel values for the two-dimensional source image. In selected embodiments, the media acceleration hardware unit is adapted to generate a plurality of temporally shifted images from the source image by sequentially shifting an origin point for a frame applied to the source image by less than an interpixel spacing distance, thereby generating the plurality of temporally shifted images for display at the display screen. The media acceleration hardware may also be adapted to generate the temporally shifted images by scaling source image pixel values from each shifted frame, thereby generating the plurality of temporally shifted images having a second, relatively low resolution for display at the display screen. The scaling may be implemented with a downsampler configured to downsample the source image pixel values to reduce pixel density by a predetermined factor in a vertical and/or horizontal direction, In selected embodiments, the media acceleration hardware may be implemented with a graphics processing unit (GPU) hardware decoder that includes an image decoder, origin shifter, and image scaler. The image decoder receives the source image having the first digital format and produces a decoded image having an RGB format, YUV format, or any desired color space. The origin shifter applies a plurality of frames to the decoded image, where each frame is shifted by less than an interpixel spacing distance and is used to generate a shifted decoded image, The image scaler changes a picture size of each decoded image to produce a plurality of scaled shifted decoded images having the second, relatively low resolution for display at the display screen, In other embodiments, the media acceleration hardware is adapted to increase color depth values from the source image by selecting a pixel value and an associated plurality of pixel values from the source image having a first, relatively small bit depth, and computing from the plurality of pixel values an average color depth value having a second, relatively large bit depth to replace the selected pixel value. For example, each 8-bit pixel value in the source image may be selected and replaced by the media acceleration hardware with a 10-bit pixel value that is computed by averaging the plurality of pixel values associated with the selected 8-bit pixel value.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram representation of a conventional display or playback device.

FIG. 2 shows a block diagram representation of an exemplary image processing system constructed in accordance with selected embodiments of the present invention.

FIGS. 3a-3d depict a source image and an associated sequence of shifted image frames that are shifted less than a pixel in order to illustrate selected embodiments of the present invention.

FIG. 4 depicts a first image frame and a second shifted image frame that is shifted less than a pixel in order to illustrate selected embodiments of the present invention.

FIG. 5 depicts a process flow sequence for implementing selected embodiments of the present invention.

### DETAILED DESCRIPTION

An improved display device and associated method of operation are described for image processing which takes advantage of increased computing power provided by graphics processing units. In selected embodiments, high resolution source images are processed to increase apparent visual resolution by introducing a temporal display factor whereby slightly shifted versions of a source image are re-scaled and displayed over time by using CPU and GPU components to perform computing tasks. The image shifting techniques may also be applied to 3D source image information by first subtracting the 3D information and then applying the image shifting technique. Any apparent motion of the displayed image may be controlled by increasing or decreasing the time between image shifts and increasing or decreasing the fractional distance shifted per time period. In addition or in the alternative, the high resolution source images may be processed to provide greater color depth using downscaling to replace each 8-bit pixel value at the center of a window with a 10-bit pixel value that is the weighted average of all the pixels in the window.

Various illustrative embodiments of the present invention will now be described in detail with reference to the accompanying figures. While various details are set forth in the following description, it will be appreciated that the present invention may be practiced without these specific details, and that numerous implementation-specific decisions may be made to the invention described herein to achieve the device designer's specific goals, such as compliance with process technology or design-related constraints, which will vary from one implementation to another. While such a development effort might be complex and time-consuming, it would nevertheless be a routine undertaking for those of ordinary skill in the art having the benefit of this disclosure. For example, selected aspects are depicted with reference to simplified block diagram depictions rather than in detail in order to avoid limiting or obscuring the present invention.

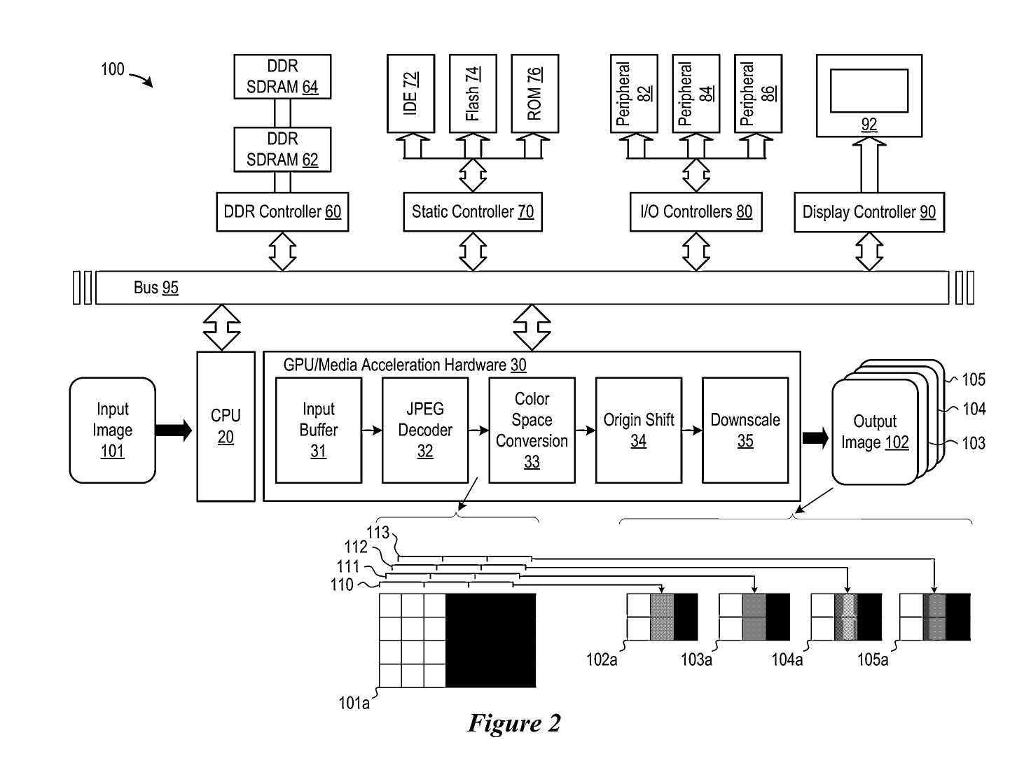

Turning now to FIG. 2, there is depicted a block diagram representation of an exemplary image processing system 100 constructed in accordance with selected embodiments of the present invention. As depicted, the image processing system 100 may implemented in any graphics or video playback device, such as desktop or, laptop computer, television, wireless or mobile device, personal digital assistants, mobile or cellular phones, DVRs, DVD and Blu-Ray players, handheld video players, digital picture frames, console game machines, projectors, tablets, digital book readers, and any other display device that processes and displays images on a fixed display screen. As depicted in FIG. 2, the image processing system 100 may be implemented as a host or applications processing unit that includes a bus 95 coupled to one or more processors or processing units 20 and a video or media acceleration hardware unit 30. In addition, the image processing system 100 may include a main memory system having a large DDR SDRAM 62, 64 that is accessed through a DDR controller 60. In addition or in the alternative, one or more memories (e.g., IDE 72, flash memory unit 74, ROM 76, etc.) are accessed through the static memory controller 70. Either or both of the DDR SDRAM or other memories may be integrated with or external to the image processing system 100. Other input/output devices may also be accessed via one or more controllers, including peripheral devices 82, 84, 86 accessed by I/O controller 80, and display device 92 which is accessed through the display controller 90. The display device may be a computer monitor or television screen having a fixed resolution pixel count and color depth, where the resolution defines the smallest noticeable detail or line that can be perceived by the human visual system, and the color depth (or bit depth) is the number of bits used to represent the color of a single pixel in a bitmapped image or video frame buffer. On the display 92, each pixel is typically formed with a plurality of sub-pixels (e.g., 3 or more sub-pixels) which each provide single-color regions that contribute to the displayed or sensed color when viewed at a distance. In addition, the number of bits used to define the range of intensity levels of each sub-pixel on the display 92 is fixed, such as 8 bits or 10 bits.

For clarity and ease of understanding, not all of the elements making up the image processing system 100 are described in detail. Such details are well known to those of ordinary skill in the art, and may vary based on the particular computer vendor and microprocessor type. Moreover, the image processing system 100 may include other buses, devices, and/or subsystems, depending on the implementation desired. For example, the image processing system 100 may include caches, modems, parallel or serial interfaces, SCSI interfaces, network interface cards, and the like. In the illustrated embodiment, the CPU 20 executes software stored in the flash memory 74 and/or SDRAM 62, 64.

As shown in FIG. 2, the image processing system 100 may be implemented with a processing platform having at least one central processing unit (CPU) 20 and at least one media acceleration hardware 30, such as a graphics processing unit (GPU). As will be appreciated, aspects of the invention could operate using only CPU 20, media acceleration hardware (e.g., GPU) 30, or a combination thereof Additionally, CPU 20 and media acceleration hardware 30 may be discrete (e.g., separate components) or may combined into a single package or die. The image processing system 100 receives an input or source image 101 that may be a high resolution JPEG image or other encoded bitstream that is encoded in a first data format and has a first relatively high resolution and fixed color depth. Under control of the CPU 20 and or media acceleration hardware 30, the input image 101 may be received over a communication network or retrieved from system memory (e.g., 62, 64), and then stored at the input buffer 31. The input image is then decoded using a predetermined image decode process, such as the JPEG decoding process at PEG decoder 32. It should be noted that other data formats may be used, including but not limited to PNG, JPEG-2000, JPEG-XR, and TIFF decoders. In addition, the disclosed technique works with bitmaps that have no compression, such as RAW camera formats. In selected embodiments, the color depth of the decoded image may then be converted using the color space converter 33 which uses spatial averaging techniques to increase the color depth of the input image. In addition or in the alternative, the decoded image data may be processed to increase the perceived spatial resolution by sequentially shifting the origin of the decoded image with the origin shifter 34 and then scaling the shifted image using image scaler 35 to thereby generate a downscaled sequence of shifted output images 102-105 that may be further encoded and formatted into a second data format for display on the display 92.

In selected embodiments, the color space converter 33 increases the color depth of the input image 101 using spatial averaging of surrounding sub-pixels. To provide increase color depth, the color space converter 33 logically promotes the initial bit depth (e.g., 8 bits per sub-pixel) to a larger bit depth (e.g., 10-bits per sub-pixel), such as by adding bit positions or converting the input image information to floating point format. A plurality of sub-pixels is the selected using a window to group pixels around a center pixel, and then used to compute an average value as the true or computed 10-bit value for the center pixel that can be sent to the display 92. For example, if four source pixels having 8-bit values of 10, 11, 12 and 13 are selected in a window surrounding a center pixel, the computed 8-bit average on a scale of 0 to 255 would be 11 since the true 11.5 value is effectively truncated by the 8-bit length. However, by computing the average on a 10-bit scale of 0 to 1023, the computed 10-bit average of 46 is truer value since it does not discard the 0.5 fraction. In this way, the color space converter 33 may compute a simple average of the surrounding source pixels, but other types of averaging computations may be performed. For example, each pixel at the center of the window may be replaced by a weighted average of all the pixels in the window. Though described with reference to an example process which selects and replaces each 8-bit pixel value in the source image with an averaged 10-bit pixel value, it will be appreciated that this is just an example, and the color depth could increased by any desired amount, such as converting from 6 to 8 bits, 8 to 9 bits, 8 to 12 bits, etc. The quantity of significant data obtained is mathematically defined by the ratio of the downsampling. For example, a downsample of 2 in both the x and y directions (a ratio of 4:1) provides two doublings, where each doubling provides one additional bit of significance to be added to the per pixel color depth. With a 16 megapixel image downscaled to a 2 MP display using three (2−>4−>8−>16), the color depth could be increased from 8 bits to 11 bits. As will be appreciated, the color depth conversion is independent from actually having a display technology that is capable of displaying this many bits of color depth, though many TVs and computer monitor makers now support 10 or 12 bit color.

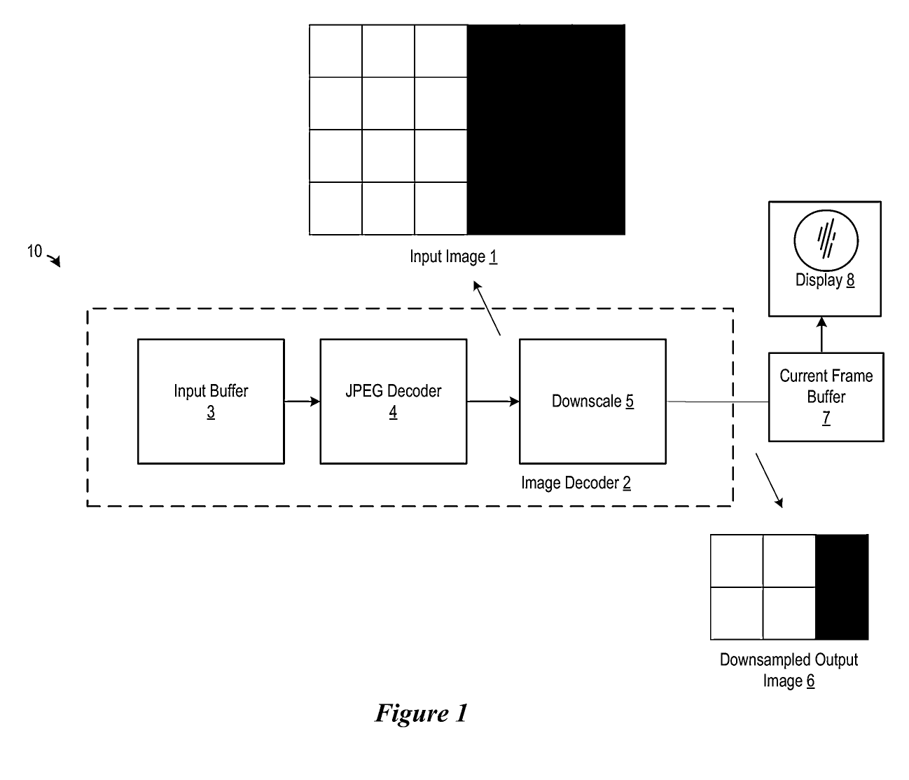

In addition, the high resolution input image 101 may be processed to increase apparent visual resolution by resealing a plurality of slightly shifted versions of the input image for display over time, thereby generating a sequence of output images 102-105 that are routed across the bus 95 and controller 90 for the display 92. To this end, each input image 101 is processed by the origin shifter 34 to shift the decoded input image by a predetermined amount, typically less than one pixel in distance, and the resulting shifted images are then resealed using the downscaler 35. In an example scenario where the input image 101 has a resolution of 3840×2160 and the display 92 has the capability to show 1920×1080 pixels, the origin shifter 34 may be configured to shift the frame a fractional pixel distance to the right, and the downscaler 35 may be configured to process every block of 2×2 pixels as an average value that is used to generate one output pixel, though any desired scaling algorithm may be used. In this scenario, an initial or reference frame would be applied by the origin shifter 34 to the decoded input image having an image detail portion 101a, and then rescaled by downscaler 35 to generate a first scaled output image 102 having a corresponding image detail portion 102a. The processing of the initial frame is indicated by the first downscale block grouping 110 applied to the input image detail portion 101a which generates the corresponding image detail portion 102a. Subsequently, the origin shifter 34 shifts the origin of the applied frame slightly to the right (e.g., by 0.3 times a single pixel distance) and the downscaler 35 rescales the shifted image to generate a second scaled output image 103 having a corresponding image detail portion 103a. The processing of the first shifted frame is indicated by the second downscale block grouping 111 applied to the input image detail portion 101a which generates the corresponding image detail portion 103a. The shift-and-rescale processing can be repeated to generate additional scaled output images 104, 105 having corresponding image detail portions 104a, 105a, as indicated by downscale block groupings 112, 113. As shown with the sequence of image detail portions 102a-105a, the shift-and-rescale processing generates output images that will be perceived over time to have sharper, higher resolution contrast than the static image processing such as shown in FIG. 1.

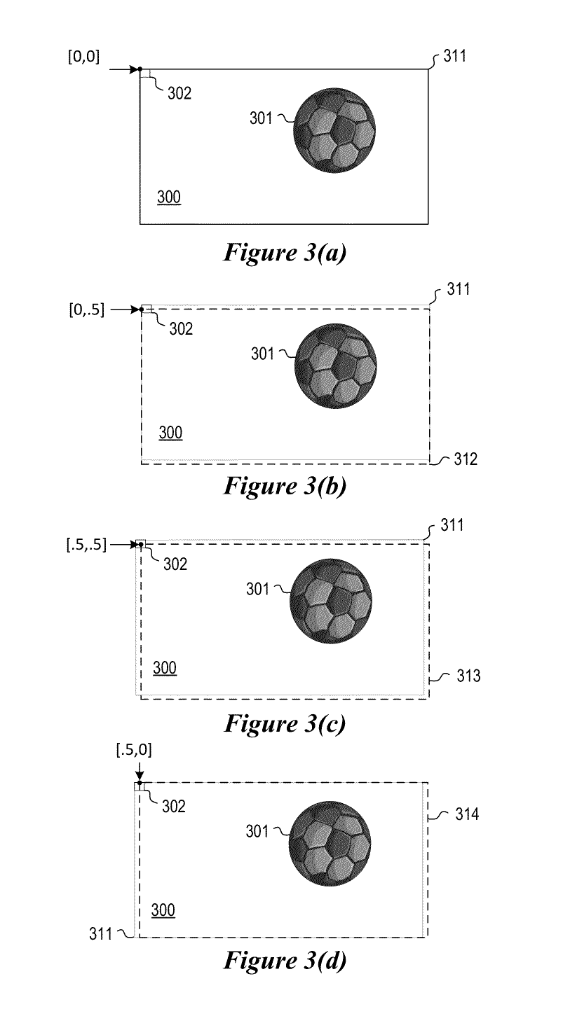

It will be appreciated that the timing and pattern of image shifting provided by origin shifter 34 may be adjusted and controlled as desired when generating the sequence of output images. If desired, the origin may be shifted randomly or in a predetermined pattern, such as an Archimedean spiral, a diagonal line, a square spiral, or alternating between two or more points. For example, FIGS. 3a-3d depict a source image 300 and an associated sequence of shifted image frames 311-314 that are shifted in two dimensions by less than a pixel distance. In the example image 300, there is depicted an image of a soccer ball 301 in a first position, and a group of four pixels 302 is shown in the upper left corner or origin of the image 300, though it will be appreciated that the pixel group 302 is not drawn to scale. Under control of the origin shifter, the initial or reference frame 311 is shown in FIG. 3a as being initially positioned (e.g., at time 0) with reference: to the [0, 0] origin point, or the upper left pixel of the pixel group 302. Using the initial reference frame 311, the image is then resealed using any desired scaling algorithm, such as a bi-linear filter, to generate a first downscaled output image. At a subsequent time interval (e.g., time 1), the origin point is changed to create a second shifted frame that is located a predetermined fractional distance in the x and/or y direction from the original reference frame 311 (shown with gray lines in FIG. 3(b)). In FIG. 3b, the second reference frame 312 is shown with dashed lines as being positioned (e.g., at time 1) with reference to the shifted origin point [0, 0.5] so that the frame 312 is shifted down less than one pixel distance. Using the shifted reference frame 312, the image is then resealed using any desired scaling algorithm to generate a second downscaled output image. The sequence of processing steps may be repeated to shift origin point to create one or more shifted frames 313, 314 shown with dashed lines as being subsequently positioned (e.g., at time 2 and time 3) with reference to the shifted origin point so that the frame 313 (in FIG. 3(c)) is shifted to new origin point [0.5, 0.5] and the frame 314 (in FIG. 3(d)) is shifted to new origin point [0.5, 0].

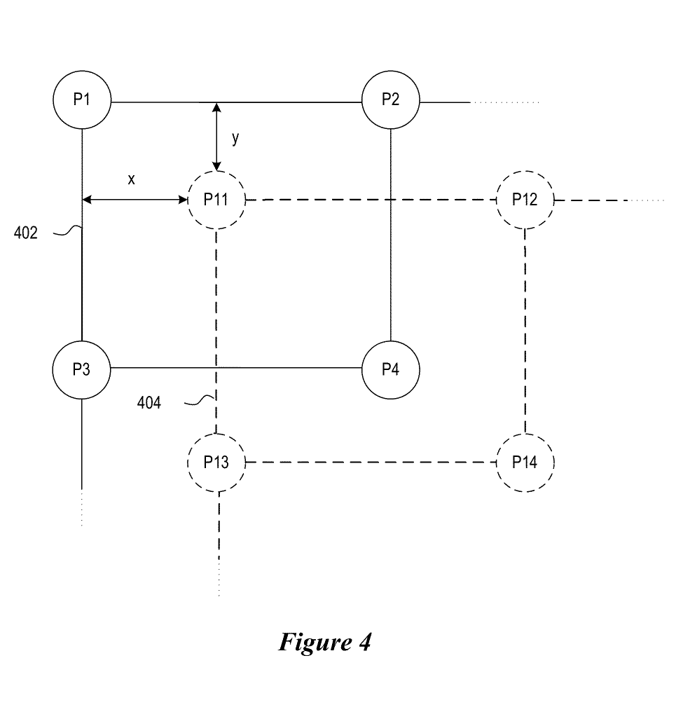

As described herein, the origin shifter 34 may use the source image pixel values to compute the shifted pixel values. To illustrate an example bilinear interpolation computation used to shift the source image, reference is now made to FIG. 4 which depicts a first image frame 402, and a second shifted image frame 404 that is shifted less than a pixel in length. As depicted, the pixels P1, P2, P3, P4 define the source image, and are spaced apart by a defined minimum pixel distance. The first image frame 402 is applied to the source pixels P1, P2, P3, P5 such that pixel P1 is the origin point for the first image frame 402. The second image frame 404 is shifted in relation to the first image frame 402 by fractional lateral distance x and fractional vertical distance y, where both x and y are less than the defined minimum pixel distance. Using bilinear interpolation, the shifted pixel value P11 may be computed as P₁₁=(1−x)(1−y)P₁+x(1−y)P²+(1−x)yP₃+xyP₄, with corresponding computations for shifted pixels P2, P3, P4. Of course, other bilinear interpolation weight computations may be used to compute shifted pixel values.

It will also be appreciated that the downscaling operation performed by the downscaler 35 may be adjusted and controlled to embody in any desired scaling process or circuit that takes input image and resizes it according to a defined ratio. In general, image scaling function changes the picture size of a video and/or adjusts the image for playback between different types of devices. In operation, the downscaling function uses a window to select a group of pixels in a source image, and then replaces a pixel at the center of a window with a weighted average of all the pixels in the window. In selected embodiments, image scaling may be implemented using an averaging filter and triangle filter for downscaling. The scaling process may be implemented as a CPU scaler or a CPU scaler, which may be a hardware scaler or programmable pixel shader.

The subtle re-positioning of the origin point within the image may cause some very fine edges in the image to appear sharper than they would otherwise in a purely static image, but the motion is very slight. This same effect is observed with videos that are panning across a fine texture. If the video is paused, the texture appears a bit blurry and is not easily recognized, but as the video runs, temporal averaging allows the human visual system to clearly see and understand what the texture is. Using the image shifting technique disclosed herein, a video paused on a single frame would not be statically shown, but would instead be displayed over and over with our very subtle movement created by slightly shilling or re-positioning the origin. The amount of image motion may be controlled by increasing or decreasing the time between image shifts and/or by increasing or decreasing the fractional distance moved per time period. In order to evaluate the effectiveness of image shifting patterns, one or more test images may be evaluated against a proposed shift pattern using different frame rates to determine if there is an improvement in perceived image resolution. In selected embodiments, a frame rate of 10-20 frames/sec was found to create minimal artifacts, and a shift pattern of alternating the origin between two points (0,0) and (0.5,0.5) was found to provide the best improvement in perceived image resolution with the least amount of side effects. Different image types and display types may have different characteristics.

In addition to processing two-dimensional source images and video still images as described hereinabove, selected embodiments of the present invention may also be applied to render 3D stereoscopic video as 2D images having increased color depth and apparent resolution than the baseline image. This may be achieved by processing the stereoscopic 3D video image information in which there are two images (one for each eye) so as to remove the 3D information, and then averaging the co-located pixels in order to generate an increase in sub-pixel color depth. In addition, apparent spatial resolution may be increased by subtracting out the 3D information, and then using the shift-and-rescale processing as described herein. In an example scenario where a 3D video information is provided having a defined video resolution (e.g., 1920×1080), the 3D information may be removed using any desired image subtraction technique. For example, a motion estimation algorithm may be applied between the two complete left and right eye images such that the images from the two eyes are now converged back to a 2D image. The “motion” is actually the parallax difference between the two eyes. In areas where the image is at “infinity” (in camera terminology), there will be no parallax, and thus no motion. In other areas, there will be motion, and these small motion vectors can be “removed.” Another subtraction technique may be used with a 3D source stream that includes a base video stream plus a delta. In this case, the “delta” information can be used directly without the need to find the motion vectors.

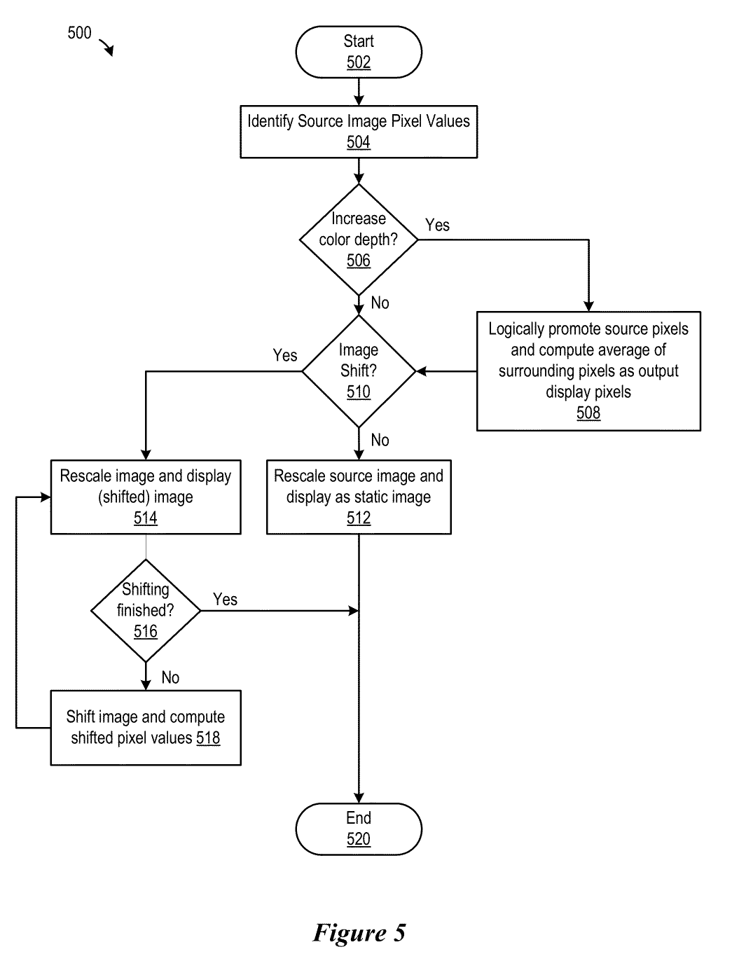

Turning now to FIG. 5, an exemplary image processing flow sequence 500 is illustrated for displaying an image with increased color depth and apparent visual resolution. After the method begins at step 502, a source image is received (step 504), such as by retrieving a high resolution image from memory or pausing a high resolution video stream. In an example embodiment, the retrieved image is a high resolution JPEG image, such as a photo from a camera with a resolution of 3840×2160 and an 8-bit color depth, and the pixel values are identified for the retrieved image.

At step 506, it is determined if the image is to be processed to increase its color depth. If not (negative outcome to decision 508), then the image processing flow sequence proceeds to step 510. However, if the image color depth is to be increased (affirmative outcome to decision 508), then the KGB image values are processed to convert or increase their color depth values. The color depth conversion processing may be implemented by first logically promoting the source pixels (or sub-pixels), such as by converting the 8-bit color depth values to 10-bit color depth values. In addition, the color depth for each (sub)pixel is then recomputed as the average of the surrounding pixels (or sub-pixels), thereby increasing the color depth for each (sub)pixel.

At step 510, it is determined if the image processing fifty sequence includes image shifting. If not (negative outcome to decision 510), then the image processing flow sequence proceeds to step 512 where the source image is resealed and then displayed as a static image. However, if the image processing flow sequence does include image shifting (affirmative outcome to decision 510), then the source image is resealed and displayed (step 514), and for so long as the image shifting is required (negative outcome to decision 516), the image frame is shifted to compute shifted pixel values (step 518), and then the shifted image pixels are resealed and displayed (step 514) in a process loop. By looping the image shift steps back through step 514, a sequence of slightly shifted output images are generated and displayed until such time as the image shifting is done (affirmative outcome to decision 516), at which point the sequence ends (step 520). As will be appreciated, any desired image scaling algorithm may be used at step 514, including but not limited to simple pixel averaging, bilinear filtering, etc. In addition, the determination at step 516 may use a predetermined shift pattern applied at a specified output frame rate, a timer clock, or even an externally provided “finish” signal to decide when the shifting is finished. Finally, the computation of the shifted pixel values at step 518 may be performed on the ROB images pixel values using any desired interpolation computation technique.

By now it will be appreciated that there is disclosed herein a method and apparatus for processing an input image for display. In the disclosed methodology, a decoded input source image is generated that has a first image resolution, such as by applying a JPEG, PNG, JPEG-2000, JPEG-XR, or TIFF decoding process to an input image. The decoded input source image may be generated from a paused video image, or transformed from 3D input source information by converging left and right images from the 3D input source information into co-located pixel values for a two-dimensional input source image. From the decoded input source image, temporally shifted and scaled images are generated for display at a display screen having a second, lower image resolution by applying a plurality of shifted image frames to the decoded input source image and scaling pixel values in each frame to match the second, lower image resolution. In selected embodiments, the temporally shifted and scaled images are generated by sequentially shifting an origin point for a frame applied to the decoded input source image by less than an interpixel spacing distance. The origin point may be shifted randomly or using an Archimedean spiral pattern, a diagonal line pattern, a square spiral pattern, or by alternating between two or more points. In addition, color depth values from the decoded input source image may be increased by replacing each pixel value from the decoded input source image having a first, relatively small bit depth with an average color depth value having a second, relatively large bit depth that is computed from a plurality of surrounding pixel values from the decoded input source image. Finally, the temporally shifted and scaled images are displayed on the display screen having a second, lower image resolution.

In another form, there is disclosed a method and associated apparatus for processing an input image for display. As disclosed, an input source image is generated that has a first plurality of pixel values with a first color depth. The first plurality of pixel values are converted to a second plurality of pixel values with an increased color depth by replacing each pixel value from the first plurality of pixel values with an average color depth value having a second larger color depth that is computed from a plurality of surrounding pixel values from the first plurality of pixel values. In an example embodiment, the first plurality of pixel values are converted by selecting and replacing each 8-bit pixel value in the input source image with a 10-bit pixel value that is computed by averaging a plurality of pixel values surrounding the selected 8-bit pixel value, though other bit depths may be generated. Finally, the second plurality of pixel values are processed for display on a display screen having the second larger color depth. The display processing may include scaling the second plurality of pixel values for display on the display screen having a resolution that is lower than the input source image resolution. In addition, the display processing may include generating temporally shifted and scaled images from the second plurality of pixel values by applying a plurality of shifted image frames to the second plurality of pixel values which are shifted by less than an interpixel spacing distance and scaling pixel values in each image frame for display on the display screen. In this way, the temporally shifted and scaled images may be displayed on the display screen having a resolution that is lower than the input source image resolution.

As described herein, selected aspects of the invention as disclosed above may be implemented in hardware or software. For example, selected aspects of the embodiments described above may be implemented as functionality programmed into any of a variety of circuitry, including but not limited to programmable logic devices (PLDs), such as field programmable gate arrays (FPGAs), programmable array logic (PAL) devices, electrically programmable logic and memory devices, and standard cell-based devices, as well as application specific integrated circuits (ASICs) and fully custom integrated circuits. Some other possibilities for implementing aspects of the embodiments include microcontrollers with memory (such as electronically erasable programmable read only memory (EEPROM), Flash memory, etc.), embedded microprocessors, firmware, software, etc. Furthermore, aspects of the embodiments may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (MOSFET) technologies such as complementary metal-oxide semiconductor (CMOS), bipolar technologies such as emitter-coupled logic (ECL), polymer technologies (e.g., silicon-conjugated polymer and metal-conjugated polymer-metal structures), mixed analog and digital, etc. Thus, sonic portions of the detailed descriptions herein are consequently presented in terms of a hardware-implemented process and some portions of the detailed descriptions herein are consequently presented in terms of a software-implemented process involving symbolic representations of operations on data bits within a memory of a computing system or computing device. Generally speaking, computer hardware is the physical part of a computer, including its digital circuitry, as distinguished from the computer software that executes within the hardware. The hardware of a computer is infrequently changed, in comparison with software and hardware data, which are “soft” in the sense that they are readily created, modified or erased on the computer. These descriptions and representations are the means used by those in the art to convey most effectively the substance of their work to others skilled in the art using both hardware and software. Hardware embodiments of the invention may be fabricated based upon software code (e.g., Verilog, HDL, RTL or GDSII data) that is used to configure (e.g. through specific maskworks) a fabrication facility so as to manufacture a device embodying aspects of the present invention.

In other embodiments, there is disclosed a computer program embodied on a computer-readable medium that stores instructions operable to control operation of one or more processors or circuits to perform image processing on a source image for display by generating a plurality of temporally shifted images from a source image by sequentially shifting an origin point for a frame applied to the source image by less than an interpixel spacing distance, thereby generating the plurality of temporally shifted images for display at a display screen. As will be appreciated, any software-implemented aspects may be encoded on some form of program storage medium or implemented over some type of tangible transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art.

The particular embodiments disclosed above are illustrative only and should not be taken as limitations upon the present invention, as the invention may be modified and practiced in different but equivalent manners apparent to those skilled in the art having the benefit of the teachings herein. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

What is claimed is:

1. An image processing system for displaying a source image, comprising:
a media acceleration hardware unit adapted to generate a plurality of temporally shifted images from a source image having a first digital image with a first resolution by sequentially shifting an origin point for a frame applied to the source image by less than an interpixel spacing distance, thereby generating the plurality of temporally shifted images for display at a display screen.

2. The image processing system of claim 1, where the media acceleration hardware comprises:
an image decoder for receiving the source image having the first digital format and producing a decoded image;
an origin shifter for applying a plurality of frames to the decoded image. where each frame is shifted by less than an interpixel spacing distance and is used to generate a shifted decoded image; and
a scaler for changing a picture size of each decoded image to produce a plurality of scaled shifted decoded images having the second, relatively low resolution for display at the display screen.

3. The image processing system of claim 1, where the media acceleration hardware is adapted to generate the plurality of temporally shifted images from the source image by scaling source image pixel values from each shifted frame, thereby generating the plurality of temporally shifted images having a second, relatively low resolution for display at the display screen.

4. The image processing system of claim 3, where the media acceleration hardware comprises a downsampler configured to downsample the source image pixel values to reduce pixel density by a predetermined factor in a vertical and/or horizontal direction.

5. The image processing system of claim 1, where the source image is a paused video image.

6. The image processing system of claim 1, where the media acceleration hardware is adapted to increase color depth values from the source image by selecting a pixel value and an associated plurality of pixel values from the source image having a first, relatively small bit depth, and computing from the plurality of pixel values an average color depth value having a second, relatively large bit depth to replace the selected pixel value.

7. The image processing system of claim 6, where the media acceleration hardware is adapted to select and replace each 8-bit pixel value in the source image with a 10-bit pixel value that is computed by averaging the plurality of pixel values associated with the selected 8-bit pixel value.

8. The image processing system of claim 1, where the media acceleration hardware is adapted to transform three-dimensional input source information into a two-dimensional source image by converging left and right images from the three-dimensional input source information into co-located pixel values for the two-dimensional source image.

8. The image processing system of claim 1, where the media acceleration hardware is adapted to transform three-dimensional input source information into a two-dimensional source image by converging left and right images from the three-dimensional input source information into co-located pixel values for the two-dimensional source image.

9. The image processing system of claim 1, further comprising:
a memory for storing a source image having a first digital format with a first, relatively high resolution; and
a display screen for displaying images,

10. A method of processing an input image for display, comprising:
generating a decoded input source image having a first image resolution;
generating from the decoded input source image a plurality of temporally shifted and scaled images for display at a display screen having a second, lower image resolution by applying a plurality of shifted image frames to the decoded input source image and scaling pixel values in each frame to match the second, lower image resolution.

11. The method of claim 10, where generating the decoded input source image comprises applying a JPEG, PNG, JPEG-2000, JPEG-XR, or TIFF decoding process to an input image.

12. The method of claim 10, where generating the plurality of temporally shifted and scaled images comprises sequentially shifting an origin point for a frame applied to the decoded input source image by less than an interpixel spacing distance.

13. The method of claim 12, where sequentially shifting the origin point comprises randomly shifting the origin point for each frame by less than an interpixel spacing distance from a previous frame.

14. The method of claim 12, where sequentially shifting the origin point comprises shifting the origin point for each frame by less than an interpixel spacing distance using an Archimedean spiral pattern, a diagonal line pattern a square spiral pattern, or by alternating between two or more points.

15. The method of claim 10, further comprising increasing color depth values from the decoded input source image by replacing each pixel value from the decoded input source image having a first, relatively small bit depth with an average color depth value having a second, relatively large bit depth that is computed from a plurality of surrounding pixel values from the decoded input source image.

16. The method of claim 10, where the decoded input source image is generated from a paused video image.

17. The method of claim 10, further comprising transforming three-dimensional input source information into a two-dimensional input source image by converging left and right images from the three-dimensional input source information into co-located pixel values for the two-dimensional input source image.

18. The method of claim 10, further comprising displaying the plurality of temporally shifted and scaled images on the display screen haying a second, lower image resolution.

19. A method of processing an input image for display, comprising:
generating an input source image with a first plurality of pixel values having a first color depth;
converting the first plurality of pixel values to a second plurality of pixel values having an increased color depth by replacing each pixel value from the first plurality of pixel values with an average color depth value having a second larger color depth that is computed from a plurality of surrounding pixel values from the first plurality of pixel values; and
processing the second plurality of pixel values for display a display screen having the second larger color depth.

20. The method of claim 19, where converting the first plurality of pixel values comprises selecting and replacing each 8-bit pixel value in the input source image with a 10-bit pixel value that is computed by averaging a plurality of pixel values surrounding the selected 8-bit pixel value.

21. The method of claim 19, where processing the second plurality of pixel values for display comprises scaling the second plurality of pixel values for display on the display screen having a resolution that is lower than the input source image resolution.

22. The method of claim 19, where processing the second plurality of pixel values for display comprises:
generating from the second plurality of pixel values a plurality of temporally shifted and scaled images by applying a plurality of shifted image frames to the second plurality of pixel values which are shifted by less than an interpixel spacing distance and scaling pixel values in each image frame for display on the display screen; and
displaying the plurality of temporally shifted and scaled images on the display screen having a resolution that is lower than the input source image resolution.

23. A computer program embodied on a computer-readable medium, the computer program configured to control a processor to perform image processing on a source image for display by generating a plurality of temporally shifted images from a source image by sequentially shifting an origin point for a frame applied to the source image by less than an interpixel spacing distance, thereby generating the plurality of temporally shifted images for display at a display screen.
